(19) United States
(12) Patent Application Publication
(10) Pub. No.: US 2004/0075773 A1
(43) Pub. Date: Apr. 22, 2004

(54) Scrambler, descrambler and the program for scrambling or descrambling

(76) Inventor: Junichi Kimura, Koganei (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/602,615

(22) Filed: Jun. 25, 2003

(30) Foreign Application Priority Data
Oct. 21, 2002 (JP) 2002-305288

(51) Int. Cl. H04N 5/14; H04N 9/64

(52) U.S. Cl. 348/571; 348/725

(57) ABSTRACT

A scramble/descramble apparatus that, when applying a partial-viewing-capable scrambling to video contents, allows a distributor to apply the scrambling, or to apply a scrambling with a strength that differs from the one at the time of the encoding. The scramble/descramble apparatus is implemented by encrypting a part of a video data portion of the encoded video contents. A contents-scrambling function in the above configuration performs correct video reproduction for a terminal that has the encryption key. Meanwhile, at a terminal that has no encryption key, the function allows the viewing (i.e., partial viewing) of a part of the video contents, or the viewing of video contents whose picture-quality has been degraded. At this time, applying the scrambling can be carried out after the video has been encoded. Accordingly, an encoding-performing party and a scrambling-performing party can be mutually different parties.

### BACKGROUND OF THE INVENTION

1. Field of the Invention

The present invention relates to a video distribution system. More particularly, it relates to a scrambling method that allows a digital-encoded video to be partially viewed.

2. Description of the Related Art

A method for encoding a video in a digital manner (i.e., compressed) has been defined in ISO/IEC 14496-2 (MPEG-4) and ISO/IEC 13818-2 (MPEG-2). When delivering these codes from a server to terminals (i.e., streaming or downloading), as a first method for delivering the video to only limited terminals in a restricted manner, there exists an encryption of the data (refer to, e.g., PKCS #1: RSA Cryptography Specifications Version 2.1, An RSA Laboratories Technical Note). If, however, the encryption of the data is utilized, the content of the data is completely disturbed. Accordingly, at a terminal that has the encryption key, it is possible to view the video. On the other hand, at a terminal that has no encryption key, it becomes absolutely impossible to view a part of the video on trial.

As a second method, there has been known a video encoder with a scrambling function (i.e., scrambling-function-equipped video encoder) (refer to, e.g., JP-A-10-145772). The scrambling-function-equipped video encoder, at the time of the encoding, causes the content of data to be slightly varied which is supposed to be encoded. As a result of this, at a terminal as well that has no encryption key, it becomes possible to partially view the video (including the viewing of a video that has been partially degradated intentionally. Hereinafter, partially viewing a video will be referred to as “partial viewing). If the partial viewing is possible, at the terminal as well that has no encryption key, it becomes possible to view the manner, the outline, or the like of the video contents. This enhances an effect of promoting purchases of the encryption key or the like. Consequently, the partial viewing is an effective method in a high-quality video distribution, especially in the broadcasting or multicasting of a video.

Incidentally, hereinafter, it is assumed that the scrambling and the encryption are synonymous with each other.

### SUMMARY OF THE INVENTION

In the above-mentioned prior arts, the partial viewing of video contents is impossible in the encoding thereof. Also, in the scrambling-function-equipped video encoder, when encoding video contents, it is necessary to set up the presence or absence of the scrambling, the strength thereof, and the like. As a result, a distributor finds it impossible to apply a scrambling to the video contents, or to apply a scrambling to the video contents with a strength that differs from the one at the time of the encoding. This results in an exceeding lack of conveniences.

It is an object of the present invention to provide a scrambling method that allows a conveniences-having partial viewing for digital-encoded video contents.

In order to accomplish the above-mentioned object, it is implemented to encrypt a part of a video data portion of the digital-encoded video contents. The representative features of the invention disclosed by the present application are as follows: A digital video scrambler that parses the content of a digital-encoded inputted video stream so as to detect a header portion thereof, and that uses a generated pseudo random-number thereby to determine a substituted-character position in the inputted video stream other than the above-mentioned header portion detected, and that has a scrambling unit for performing a substituted-character processing at the determined substituted-character position.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram for explaining a first embodiment according to the present invention;

FIG. 2 is a detailed explanatory diagram for a scrambling unit;

FIGS. 3A and 3B are diagrams for explaining a state transition for determining whether or not a scrambling is possible;

FIG. 4 is a flowchart in the case where processings are implemented by software programs;

FIG. 5 illustrates an example of a substitution table;

FIG. 6 illustrates an example of a substitution-table generating algorithm;

FIG. 7 illustrates a modified embodiment of a scrambler 100 in FIG. 1; and

FIG. 8 illustrates an applied example of a video distribution system using the scrambler 100 in FIG. 1.

FIG. 9 is a block diagram illustrating a decrambling unit.

### DETAILED DESCRIPTION OF THE EMBODIMENTS

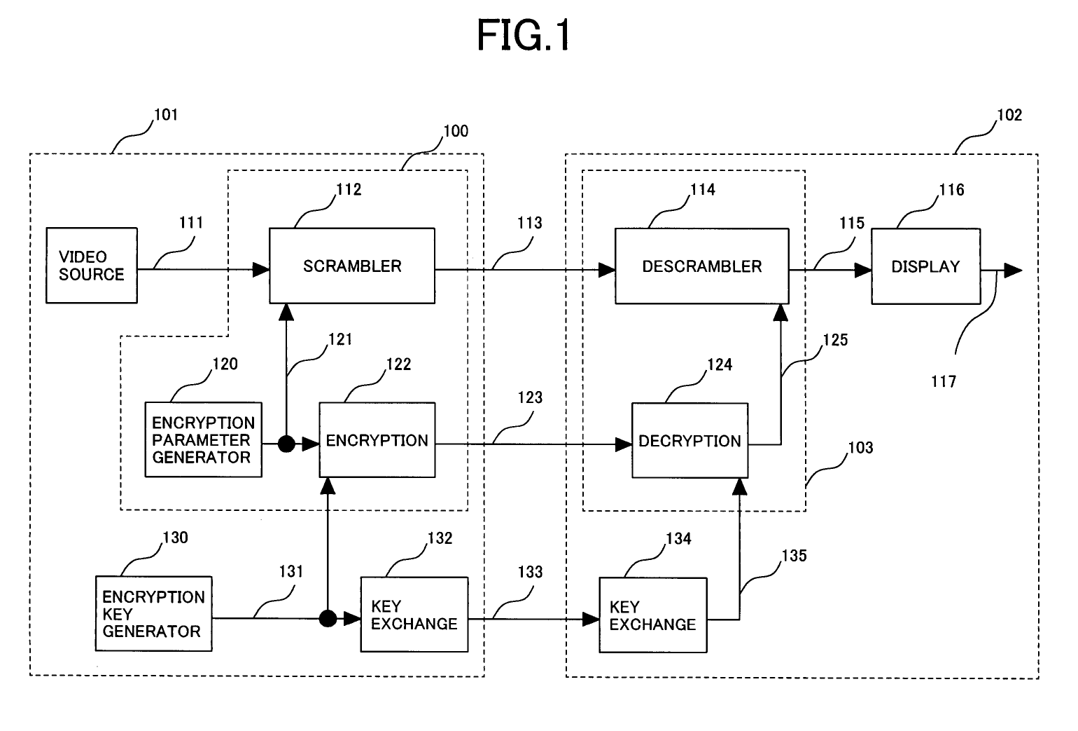

FIG. 1 illustrates a first embodiment according to the present invention. A system of FIG. 1 includes a video distribution side 101 and a video receiver side 102. The locations characteristic of the present invention are the portion of a scrambler 100 inside the delivery side, and the portion of a descrambler 103 inside the receiver side.

Hereinafter, the explanation will be given below concerning the outline of the operation. Prior to the starting of a video distribution, an encryption-key generator 130 generates an encryption key 131, and a parameter generator 120 generates scramble parameters 121. The encryption key 131 is a key for correctly encoding and viewing contents to be delivered. Also, the scramble parameters 121 are parameters that both the transmission side and the reception side share in executing a scrambling. The scramble parameters will be described later.

If an instruction of the video distribution is issued, at first, a transmission of the encryption key is performed between a transmission encryption-key exchanging unit 132 and a reception encryption-key exchanging unit 134. Generally speaking, the encryption-key exchange is performed using a high-secrecy method such as the method disclosed in PKCS #3: Diffie-Hellman Key-Agreement Standard, An RSA Laboratories Technical Note. The selection for the encryption-key exchanging method, however, is a problem that is independent of the present invention. Accordingly, the present invention can be combined with whatever encryption-key exchanging method, or even with a key exchange with no secrecy (i.e., unencrypted key delivery).

When the encryption-key exchange has been completed and the reception side has acquired a reception encryption key 135 (which corresponds to the encryption key 131), a transfer of the scramble parameters 121 is performed next. The scramble parameters 121 are encrypted by an encryption unit 122 using the encryption key 131, then being delivered as scrambled data 123. At the reception side, a decryption unit 124, using the above-described reception encryption key 135, decrypts the scrambled data 123 thus received. This allows the acquisition of reception scramble parameters 125, which correspond to the scramble parameters 121.

After the transmission side and the reception side have shared the scrambling parameter, the video distribution is performed. Namely, a part of the data of a video stream 111 is transformed by a scrambler 112 using the scramble parameters 121, and then the video stream is outputted as a scramble stream 113. Meanwhile, at the reception side, a descrambler 114 receives the scramble stream 113, then performing the descrambling of the scramble stream by using the reception scramble parameters 125. Moreover, a descrambled stream 115 (which is identical to the video stream 111) is transmitted to a reproducer 116, thereby acquiring a reproduced video 117.

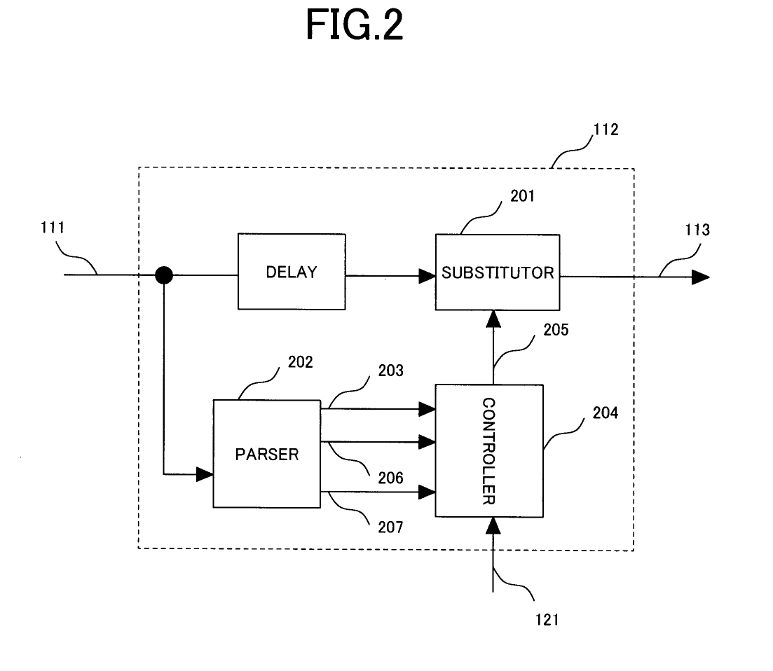

Using FIG. 2 to FIG. 5, the detailed configuration will be shown below concerning the scrambler 112.

The inputted video stream 111, in, e.g., MPEG-2 or MPEG-4, consists of a header portion and a data portion. The header portion has stored parameters (e.g., a video size, and in-time position of a video) needed for decoding data that follows the header. In order to identify the header, a start code (e.g., 23 bits of “0” continue and next, 1 bit of “1” appears. When converting this code into the hexadecimal representation by arranging this code on each 8-bit basis from the highest-order bit, the resultant representation becomes 0x00, 0x00, 0x01. The 0x” indicates that the numbers after “0x” are hexadecimal numbers) that does not appear except for the header is used at the front-head of the header portion.

The data portion, which has stored data of the video data itself, is generally encoded by a variable length code. In the variable length code, a symbol and a binary bit-string are in a one-to-one correspondence with each other, examples of which are: The code of data A is “1”, that of data B is “01”, that of data C is “00100”, that of data D is “00101”, that of data E is “00110”, and that of data F is “00111”. In the above-described example, if the inputted data is “1001010101001101101”, the data is examined from the front-head, thereby achieving such a separation as 1[A]00101[D]01[B]01[B]00110[E]1[A]1[A]01[B]. This results in an acquisition of output symbols ADBBEAAB. The meanings of the acquired symbols and the method for reproducing the video therefrom have been all specified in the standard of MPEG-2 or the one of MPEG-4. The data portion has been designed such that the above-described start code of the header portion will not appear absolutely. For example, in the example of the above-described symbols A to F, no matter what symbols' combination is achieved, 5 or more “0”s will not continue. Also, in the data portion, from the characteristics of the variable length code, the lack/inversion of even a 1-bit data makes it impossible to correctly decode the data thereinafter. In the above-described example of the inputted data, if the 3rd bit is inverted to become “1”, the separation becomes 1[A]01[B]1[A]01[B]01[B]01[B]00110[E]1[A]1[A]01[B]. This results in an acquisition of output symbols ABABBBEAAB. The resultant data differs from the correct-case symbols ADBBEAAB, and what is more, the number of symbols itself has changed from 8 to 10. Moreover, in MPEG-2 or MPEG-4, there exist many cases where the type and the code table of data that is next to one symbol differ depending on the content of the one symbol. This makes it difficult to perform the reproduction after the data lack/inversion.

The scrambler 112 protects the header portion of the inputted video stream, and applies a scrambling to only (a part of) the non-header portion, i.e., the data portion, by a substitutor 201. This allows the scrambler 112 to perform an appropriate control over the picture-quality of a partial viewing at a terminal that has no encryption key. When converting the inputted data into the hexadecimal representation by summarizing the inputted data on each 8-bit basis, the start code of the header portion becomes 0x00, 0x00, 0x01. Consequently, a data parser 202 in FIG. 2 recognizes the start code every time the 8-bit data is inputted, and switches a start code signal 203 into a state of indicating “detection” at a point-in-time when the last 0x01 is inputted. Also, at the same time, the data parser 202, based on the data positioned directly after the start code, outputs the type of the header as a header type 206. Furthermore, if the header type is the header (i.e., picture header or VOP header) of a frame (i.e., video), the data parser outputs the type of an encoder type (e.g., intra-VOP or I (intra) picture decodable on a stand-alone basis, P-VOP or P picture configured by a differential signal from the preceding frame, and B-VOP or B picture that is not used for the prediction of another frame) of the corresponding frame as an encoder type 207.

A controller 204 parses the start code signal 203, the header type 206, and the encoder type 207 with the 8-bit-basis timing of the inputted signal 111. This allows the controller 204 to determine whether or not to apply the scrambling to the 8-bit data of the corresponding inputted signal. In the case of applying the scrambling, in accordance with a substitution table that will be described later, the controller transforms the inputted 8-bit data to predetermined 8-bit data, then outputting the predetermined 8-bit data. This data transformation prevents the reception side that has no encryption key from performing the data decryption correctly, thereby causing a degradation in the reproduced video.

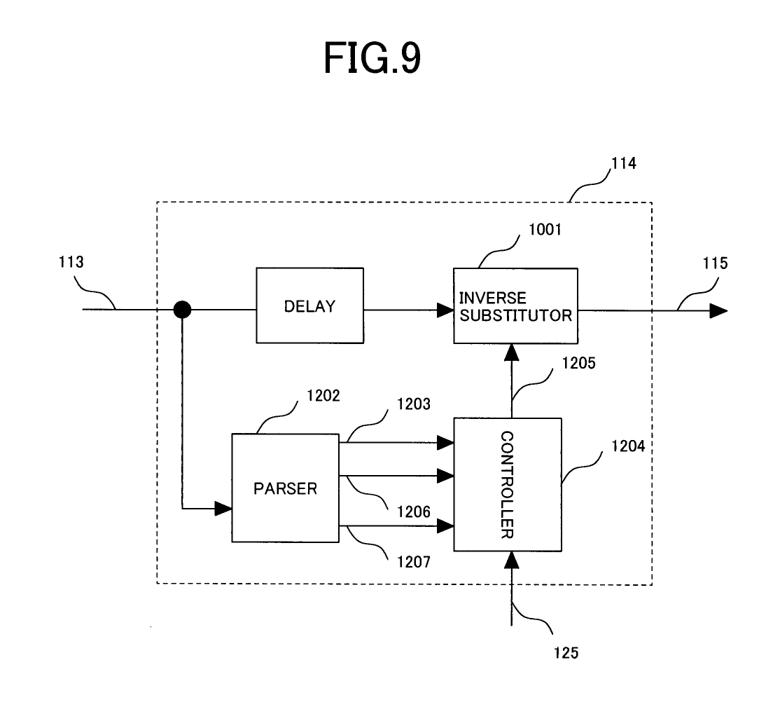

The configuration of descrambler 114, as shown in FIG. 9, is almost same as the configuration of scrambler 112. The substitutor 201 is replaced with inverse substitutor 1001.

Other components including a delay, a data parser 1202, a start code signal 1203, a controller 1204, a header type 1206 and an encoder type 1207 are same as the components in scrambler 112 including a delay, a data parser 202, a start code signal 203, controller 204, a header type 206 and an encoder type 207 respectively. The protection of header portion brings identicalness of the header portions in video stream 113 to the header portions in video stream 111. Consequently, the data parser 1202 and the controller 1204 perform exactly same as data parser 202 and the controller 204, respectively.

Descrambled stream 115 is obtained through these processings.

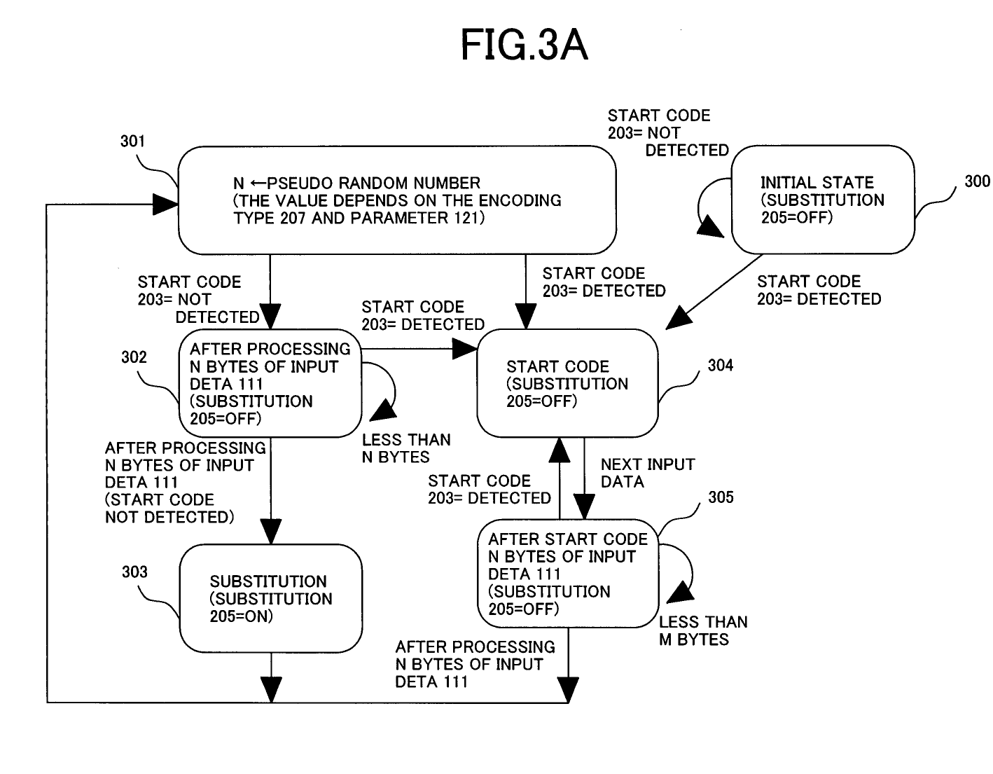

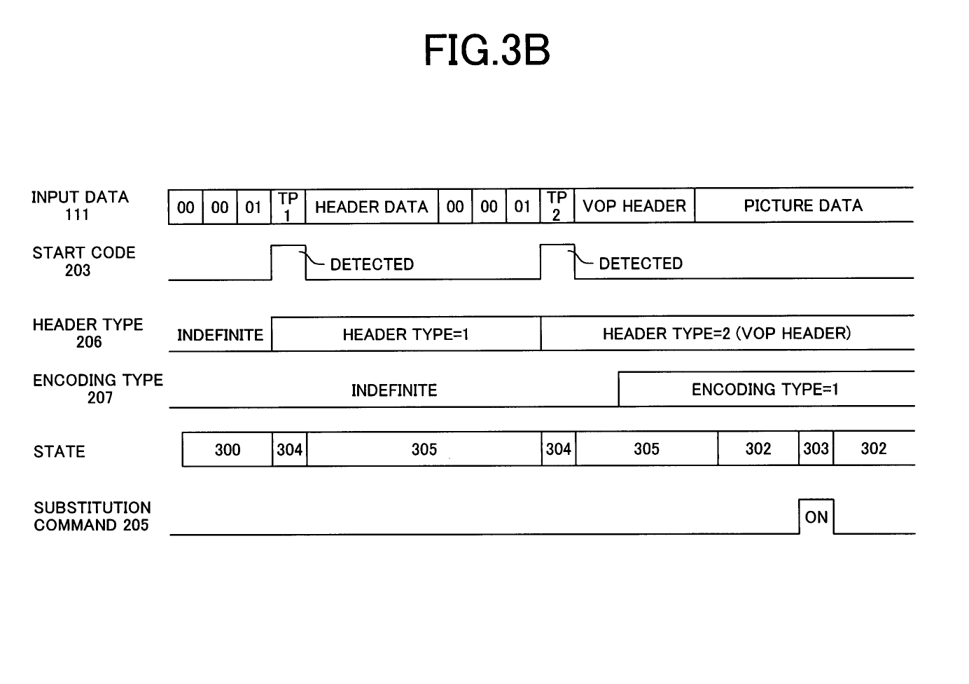

FIGS. 3A-3B illustrate state transition diagram for determining whether or not the scrambling is possible at the controller 204. If the start code has been detected, no matter what state the start code lies in, the state is transitioned to a state 304. Hereinafter, no scrambling is performed for a while, and thus the header information is outputted with no change added thereto. Concretely, if, in the state 304, the next data is inputted, the state 304 is transitioned to a state 305. In the state 305, a substitution command signal 205 is kept being switched OFF during a predetermined byte number (: M bytes), thereby suppressing the scrambling. Here, the value of M is determined by the header type 206 or the frame type 207. For example, the value of M is made larger than a standard length of each header, and is set up as follows simultaneously: In the case where the frame type is the I-VOP or the I picture, the data amount of 1 frame is generally large, and accordingly the value of M is made larger to some extent. In the case of the P-VOP or the P picture, the value of M is made somewhat smaller. In the case of the B-VOP or the B picture, the value of M is made even shorter.

When processing the M-byte data has been finished, the state 305 is transitioned to a state 301. Depending on the state of the start code at this point-in-time, the state 301 is further transitioned to a state 302 or the state 304. In the state 301, a parameter N is determined which functions in the state 302 and a state 303 in which the data portion is processed. N indicates the number of byte until the substitution is executed in the state 302. When inputting the N-byte data, i.e., transferring the N-byte data with no substitution executed, has been finished, the state 302 is transitioned to the state 303. In the state 303, the substitution command signal 205 is switched ON, which causes the next 1 byte to be substituted. If the value of N is small, the earlier-explained degradation in the video occurs quite frequently. Meanwhile, if the value of N is large, the degradation in the video is reduced. The value of N is generated by, e.g., the following expression:

N=A+B*RND(C)

Here, as the scramble parameters, A, B, and C have been set up in advance on each frame-type basis. Also, RND (C), which is a random number that is larger than 0 and less than C, is generated by an in-advance determined calculation method every time the value of N is calculated. Since an initial value of this random number is transferred to the reception side as the scramble parameter, the random-number values coincide with each other between the transmission side and the reception side. This condition allows the reception side to know a data position at which the transmission side has performed the substitution. As the random-number generating method, an arbitrary method is available, such as the method described in Japan Institute of Electronics, Information and Communication Engineers, Technical Research Report, ISEC2001-8, 2001. Incidentally, it is assumed that the term “random number” used in the present application includes a pseudo random-number as well.

The magnitudes of the scramble parameters A and B exert influences on the picture-quality of the partial viewing. Accordingly, the magnitudes are specified directly or indirectly from the outside. At this time, the characteristic of the stream (contents stream) is caused to be reflected on this direct or indirect specification. This reflection permits the picture-quality at the time of the partial viewing to come nearer to a desired picture-quality (i.e., degradation). Concretely, depending on the I/P/B picture types, the set of A and B are switched. In particular, in order to implement a light (i.e., less degradation) partial viewing, the values of A and B on the P picture are made larger. This, namely, makes it possible to suppress an accumulation of the degradation caused by a degradation in the predicted video, thereby allowing the implementation of the stable picture-quality.

Moreover, when determining the parameters A and B, the entire inputted stream or a part thereof such as the front-head thereof is inspected in advance, or the characteristics of the stream are measured while applying the scrambling thereto. This makes it possible to amend the parameters, thereby permitting the partial-viewing picture-quality to come nearer to a more desired one. Concretely, one of or a combination of the following factors is measured: The insertion frequency of the intra picture (VOP), the insertion frequency of an intra macro block, the data length of the video packet, the data length of a slice or a GOB, and the like. These values exert influences on the resilience to a data error. For example, when the intra picture is inserted quite frequently, the recovery from a data error becomes quite likely to occur. These measured values are compared with a predetermined range that is derived from the bit rate, the frame rate, and the video size, or that has been determined in advance. Then, if these values fall outside the predetermined range, the scramble parameters are modified depending on the strength-or-weakness of the error resilience.

Also, for example, assuming 3-stage-levels (i.e., 1 to 3) video-qualities of the partial viewing, and in accordance with the following way, it becomes possible to implement a partial-viewing video at multi-stage-level: When the level is 3, the partial viewing is given to the I picture, and on the P and B pictures, A and B are made extremely small to make the partial viewing almost impossible (i.e., complete scrambling). When the level is 2, no scrambling is applied to the I picture, and the complete scrambling is applied to the P and B pictures. When the level is 1, no scrambling is applied to the I and P pictures, and the complete scrambling is applied to the B picture.

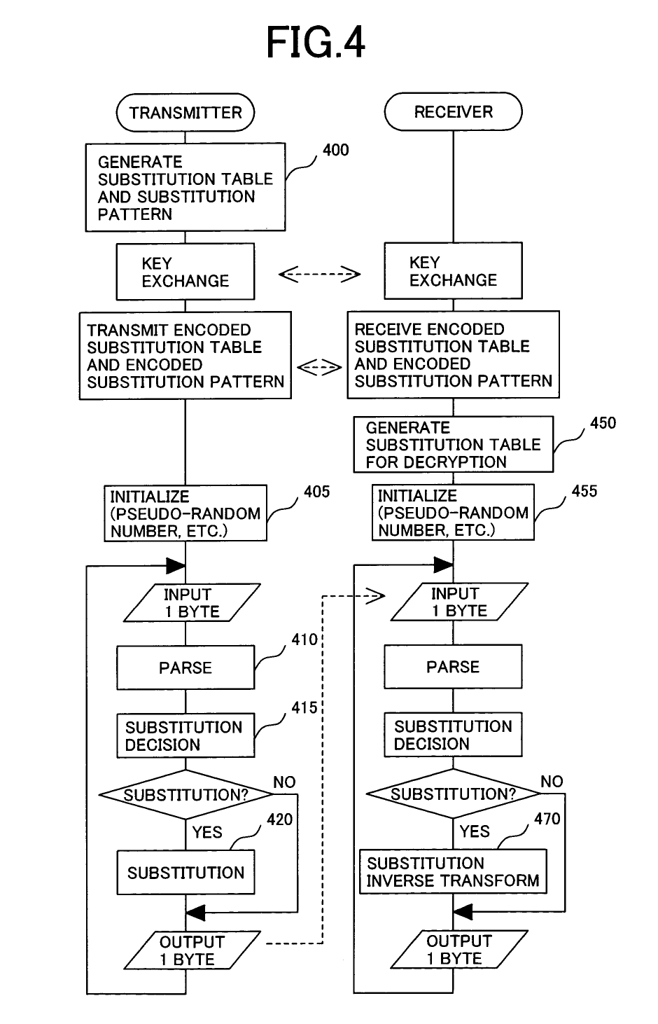

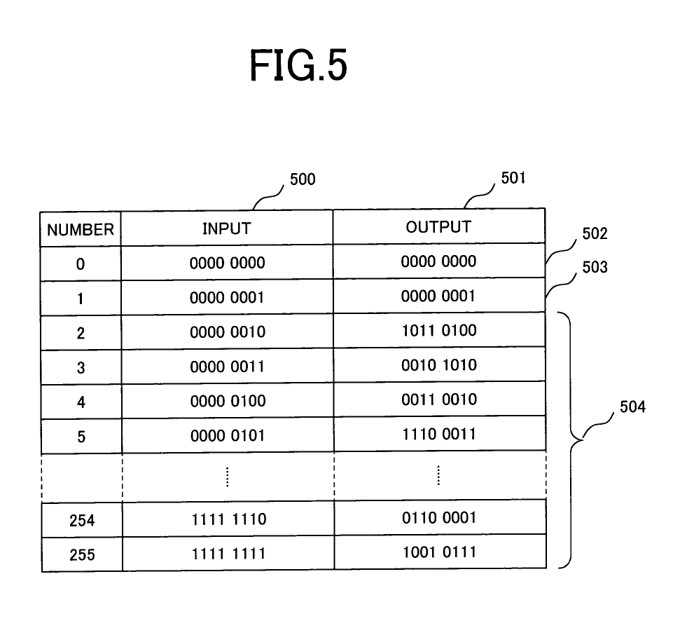

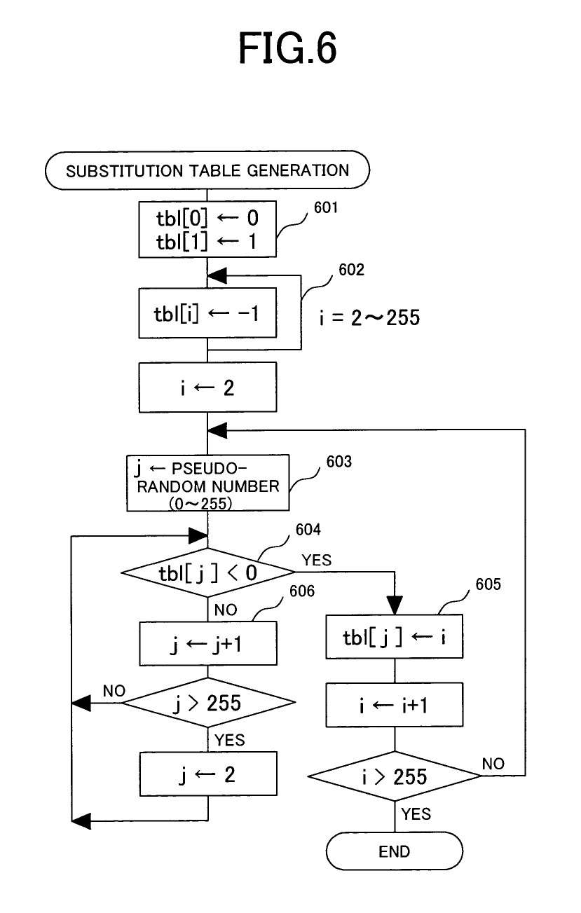

FIG. 4 is a flowchart in the case where the processings described so far are implemented by software programs. The processings until an initialization 405 at the transmission side and an initialization 455 at the reception side are the same as the processings described earlier. Here, using FIG. 5 and FIG. 6, the description will be given later concerning a substitution table creation 400 and a substitution-decrypting table creation 450.

When the initializations have been finished, the transmission side inputs the inputted stream by the amount of 1 byte. Next, at a syntax parse 410, the start code is parsed, using the method that follows the state transition in FIGS. 3A-3B. Moreover, at a substitution judgement 415, based on a value corresponding to the substitution command signal 205 in response to the state in FIGS. 3A-3B, it is determined whether or not to apply a substitution processing to the next data. In the case of executing the substitution processing, the substitution is performed at a step 420. Then, the transmission side outputs the data to which the substitution has been performed or has been not performed. Meanwhile, the reception side inputs the data inputted, i.e., the data that the transmission side has processed and outputted, then performing an operation that is completely identical to the operation at the above-described transmission side. At a substitution-decrypting processing 470, however, a substitution-decrypting transformation processing is performed which restores a transmission-side substituted character back to the original character.

FIG. 5 illustrates an example of the substitution table. A column 500 indicates the 8-bit inputted data (256 types), and a column 501 indicates output values to the respective data in the column 500. Here, concerning inputted data “00000000” (row 502) and inputted data “00000001” (row 503), the inputs are always identical to the outputs thereto, respectively. The inputs and the outputs of these 2 pieces of data are made identical to each other. This makes it possible to store the start code completely. In the remaining rows (i.e., rows 504), the values in a range of the input values 0x02 to 0xFF are arranged at random, and the respective outputs do not overlap with each other. Namely, an input value b whose output value turns out to become a is determined uniquely.

Both the transmission side and the reception side share the substitution table in FIG. 5 as the scramble parameters. At the reception side, a table is used in which the output column 501 in FIG. 5 is employed as the inputs and the input column 500 therein is employed as the outputs. This makes it possible to restore, back to the correct data, the data to which the substitution has been performed at the transmission side.

As the substitution table in FIG. 5, a fixed table may be used. Otherwise, the substitution table may be newly created on each plural-contents basis, on each contents basis, or on each part-of-contents basis (e.g., on each predetermined frame-number basis). In order to prevent an unauthorized decryption of the scrambled data (which means that a person or a party that has not obtained the key in an authorized way decrypts the scrambled data), it is desirable to exchange the substitution table as frequently as possible, and to newly create a substitution table on each exchange occasion.

FIG. 6 illustrates an example of a substitution-table generating algorithm. A substitution table is stored into 256 sequences referred to as “tbl”, and the i-th (i=0 to 255) outputted data is represented as tbl[i]. When representing, e.g., the substitution table in FIG. 5, the resultant representation is tbl[0]=0, tbl[1]=1, tbl[2]=0xB4, tbl[3]=0x2A, . . . .

At processings 601 and 602, an initialization is performed. Namely, after setting fixed values into the data 0 and the data 1, −1 is set into the remaining data (i.e., 2 to 255). Hereinafter, the case where the value of a sequence is larger than 0 (and smaller than 255) indicates that the data has been already set into the sequence. Meanwhile, the case where the value is −1 indicates that no data has been set therein.

After the initialization has been finished, a loop processing after a processing 603 is repeated 254 times. The loop processing is performed using a variable i that employs 2 as the initial value. Within the loop, at first, at the processing 603, a random number in the range of 0 to 255 is generated (, and is substituted into j). Next, at a processing 604, it is confirmed whether or not the data has been set into tbl[j]. If no data has been set therein, the processing transfers to a processing 605, where i is substituted (i.e., set) into tbl[j]. Meanwhile, if the data has been already set into tbl[j], the processing transfers to a processing 606. Here, j is incremented on a one-by-one basis (, and if j exceeds 255, j is reset to 2), thereby retrieving tbl[j] into which no data has been set. After that, at the processing 605, i is set using the value of j at the time of this retrieval, thereby completing the 1-time loop processing. This processing allows the values of 0 to 255 to be inputted into the sequences of tbl[ ] without being overlapped with each other.

Also, another generation example is as follows: After having finished the initialization as tbl[i]=i, 2 random numbers (p, q) in a range of 2 to 255 are generated, then exchanging the value of tbl[p] and that of tbl[q] mutually. Repeating this exchange processing sufficient times makes it possible to generate sequences whose outputs become random.

In either of the above-described algorithms, the existence of 1 series of random numbers allows both the transmission side and the reception side to create one and the same substitution table. Consequently, as the scramble parameters, the 256-element substitution table may be set and transmitted. Otherwise, after defining the random-number creating method between the transmission side and the reception side, the data (i.e., random-number initial value) for specifying the random-number series may be set and transmitted.

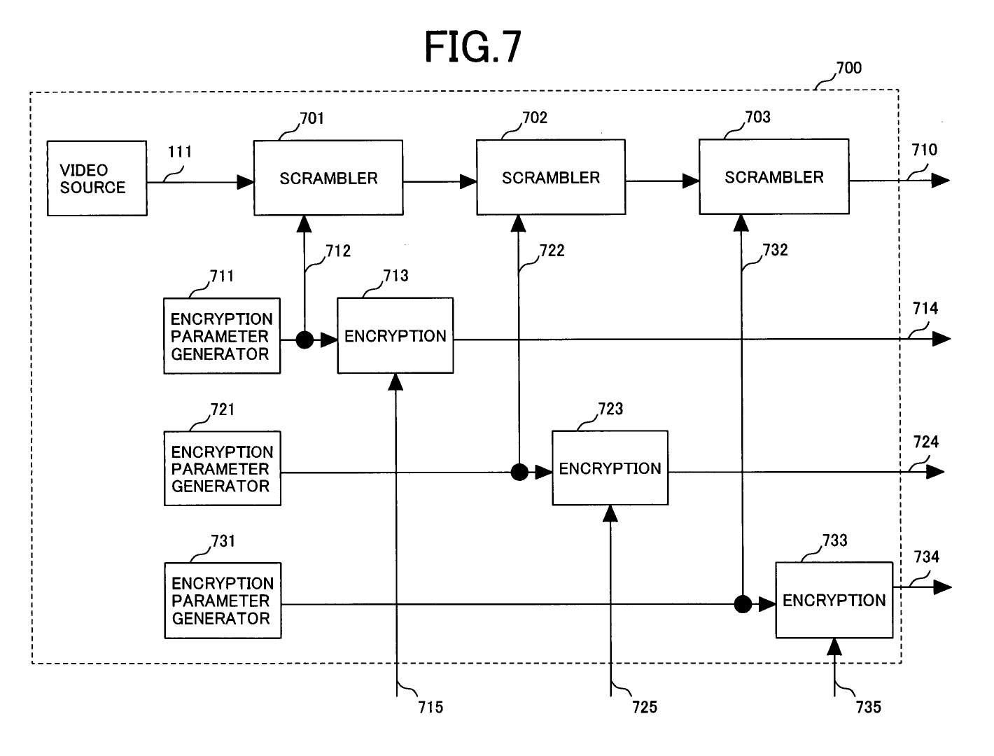

FIG. 7 illustrates a modified embodiment of the scrambler 100 in FIG. 1. In a scrambler 700, the scramble processing by the scrambler 100 is applied and repeated 3 times in series. Moreover, the respective scramblers 701, 702, and 703 never fail to apply respective substitution processings to pieces of data that exist at different positions. Specifying the different positions can be implemented as follows, for example: When dividing, by 4, the byte number existing from the close start-code position to the substitution positions, the substitution positions are specified so that the remainder becomes equal to 0 at the scrambler 701, and the remainder becomes equal to 1 at 702, and the remainder becomes equal to 2 at 703. In order to correctly reproduce a scramble stream 710 generated in this way, 3 keys each corresponding to keys 715, 725, and 735 become necessary. Nevertheless, in the cases as well where the number of the acquired keys is 0, 1, and 2, it is possible to view a video whose partial viewing is available and whose degradation is reduced as the number of the acquired keys is increased.

Also, the strength of the scrambling is changed in advance on each key basis. This, based on the presence or absence of the 3 keys for example, allows the implementation of 8-way scramblings including the normal viewing. Concerning the plural keys, for example, the 1st key is handed to a certain group beforehand, and the 2nd key with a different scrambling strength is handed to another group beforehand. This makes it possible to provide a different scrambling strength on each group basis.

In either of the above-described explanations, the assumption has been given that the header portion explained is the header portion of the video stream, i.e., the elementary stream. It is apparent, however, that the following modified embodiment is also included in the present application in a stream that results from multiplexing data other than the video stream.

The modified embodiment is the following method: In the case of the stream that results from multiplexing the video stream and a voice stream by using a system layer, only the video stream is extracted. Next, the scrambling is applied to the extracted video stream, then writing back the after-scrambled stream into the original multiplexed data. At this time, since the total data number in the stream is unchanged, the writing-back processing may be a processing of simply overwriting the original data. Namely, it is well enough to change data situated at a substitution position in the original multiplexed stream. If, in the system layer, a stream's parity/error correction code or the like is written therewith for the prevention of a data error, the parity/error correction code or the like is recalculated and amended so as to be rewritten. This makes it possible to maintain the consistency as the data. Incidentally, by making the arrangement in advance between the transmission side and the reception side, it is possible not to amend the parity/error correction code or the like, namely, not to make reference to the parity/error correction code or the like at the reception side.

In the case of the stream that results from multiplexing the video stream and the voice stream by using the system layer, a portion to be protected (which corresponds to “the header” in the above-described explanations) is dealt with as system layer data, the header of the video stream, and the voice stream. This makes it possible to directly apply, to the multiplexed system stream, the processing with respect to the video stream. In this case, the data parser 202 parses the syntax of the system layer, thereby judging which of the system layer, the video stream, and the voice stream the data under the processing belongs to. If the under-processing data is the system layer or the voice stream, the parser prohibits the substitution processing (i.e., protects the data). Meanwhile, if the data is the video stream, the parser identifies the header portion of the video stream, then judging the protection/substitution in accordance with the method explained earlier.

In the case of the multiplexed data like this, the plural scramblers according to the present invention are usable. Namely, of the multiplexed elementary stream (which results from multiplexing 2 or more streams in total, i.e., the video streams or voice/audio streams that are more than 0 in number each), independent substitution processings are applied to 2 or more streams. Concretely, this means a method where the independent scramble parameters A, B, and C are switched to each other depending on the type of the under-processing data to which the present invention is to be applied. In this case, it is also possible to perform the independent processings by using one and the same parameter. This makes it possible to reduce the data amount needed for transmitting the scramble parameters.

Incidentally, the scrambling to the voice or the audio can be carried out in a substitution processing that is basically the same as the one in the present invention. In this case, there is no need of protecting the header.

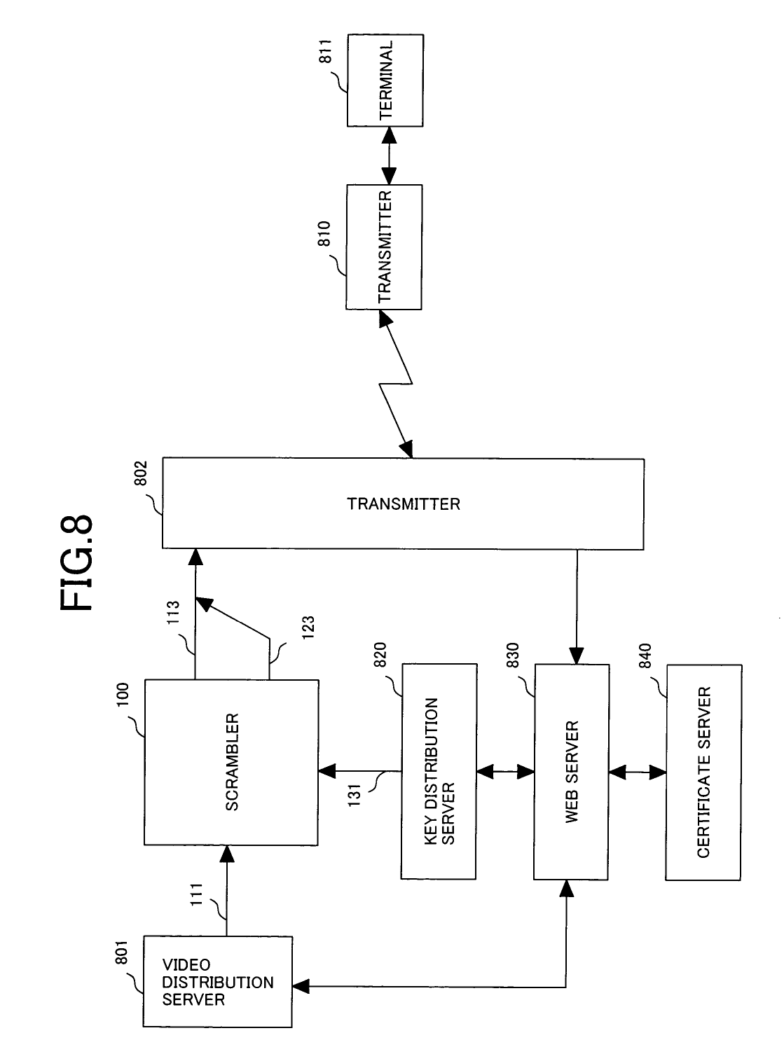

FIG. 8 illustrates an applied example of the video distribution system using the scrambler 100 in FIG. 1. Here, the broadcast delivery is assumed as the delivery method of the video stream. Namely, one and the same stream is delivered to all of receivers that wish the video distribution. Moreover, of the receivers, only a terminal that has acquired the key can view the video correctly. Also, scramble parameters 123 are sent out cyclically, then being transferred in a state of being multiplexed into the video stream 113. Here, the scramble parameters 123 have been multiplexed just before a random access point of the video stream (i.e., point at which the viewing can be started from halfway in the stream).

In FIG. 8, a user of a terminal 811 accesses a WEB server 830 via a transmitter 810, thereby acquiring information about a viewable video. The information at this time includes a snapshot of the video, the explanation by a text, the viewing method, the viewing charge, and the like. If the user wishes to view the video stream 111, the system starts the viewing of the video stream 113 under the broadcast transmission. In parallel therewith, the user sends out a key acquisition request via the WEB server 830. At this time, the user may send out the ID number, the password, the credit card number, or the like used for paying the charge. In order to confirm the authentication of the key acquisition request by the user, the WEB server 830 makes an inquiry to an authentication server 840. The content of this inquiry is, e.g., the authentication of the user ID and that of the password, or confirmation of the validity of the credit card. The authentication server makes the judgement on the authentication of the user by using user information stored in advance in the storage unit. If the authentication has been confirmed, the WEB server 830 makes a request to a key distribution server 820 for the acquisition of a decryption key corresponding to the key 131 used when the video stream 111 had been scrambled. At this time, the WEB server may attach a digital certification or the like issued by the authentication server 840. Having acquired the decryption key from the key distribution server 820, the WEB server 830 transmits the key information to the terminal 811. Using the decryption key, the terminal 811 decrypts the scramble stream 113, thereby making it possible to view the correct video.

As another modified embodiment of the system in FIG. 1, in order to confirm the authentication of the user, it is allowable to use a certification (e.g., ID code described on a receipt or the like) for certifying that the user had made a purchase at a shop or the like. In this case, the authentication server 840 in FIG. 8 establishes a connection with the POS system or the like at the shop, then performing the authentication after having confirmed the user's purchase data, purchase amount of money, and the like.

As still another modified embodiment of the system in FIG. 1, there exists an embodiment where different scramble parameters are presented on each contents basis. Namely, the modified embodiment is the following method: Contents to be inputted and scrambling instruction information corresponding to the contents to be inputted are inputted into the scrambler. Next, a scramble parameter is determined from the scrambling instruction information by a predetermined method. Moreover, using this scramble parameter, different scramblings are applied on each contents basis.

Concretely, integer values 0 to 4 for indicating scramble levels are prepared as the scrambling instruction information, and the scrambling is applied as follows: When the scramble level 0 is specified, no scrambling is applied. When the levels 1 to 3 are specified, scramblings whose partial-viewing's extents differ from each other (i.e., of 1 to 3, 3 gives picture-quality degradations more than that of 1) are applied. When the level 4 is specified, the complete scrambling (i.e., no partial viewing) is applied. Here, in the case of the complete scrambling, the strength of the contents' protection may be increased using a general cipher. Also, by making extremely small the scramble parameters A and B of the present invention's technique, the picture-quality may be degraded down to an extent at which the partial viewing becomes impossible.

When the levels 1 to 3 are instructed as the scrambling instruction information, the scrambler selects the scramble parameters (i.e., values of A and B, basically) prepared in advance. Incidentally, at this time, the earlier-described inspection of the inputted stream is carried out and, based on this inspection result, the scramble parameters are amended. This makes it possible to expect a more appropriate partially-viewed image. According to the present configuration, by presenting the key for the video viewing as, e.g., a prize of a purchase at a shop or the like, it becomes possible to view the contents. This makes it possible to expect an effect of promoting purchases at the shop. Also, since even a client who has no key can enjoy the partial viewing of the video, the client wishes to watch the video correctly. This makes it possible to expect an effect of promoting the purchases of goods at the shop.

The contents-scrambling function of the present invention performs correct video reproduction for a terminal that has the encryption key. Meanwhile, at a terminal that has no encryption key, the contents-scrambling function allows the viewing (i.e., partial viewing) of a part of video contents, or the viewing of video contents whose picture-quality has been degraded. At this time, applying the scrambling can be carried out after the video has been encoded. Accordingly, an encoding-performing party and a scrambling-performing party can be mutually different parties. Moreover, selecting the parameter of a scrambling makes it possible to select the strength of the scrambling.

Furthermore, according to the configuration where the multi-stage scrambling is performed, plural keys are used. This condition, based on the number/combination of keys that a receiver acquires, makes it possible to change the picture-quality of a video whose partial viewing is possible.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A digital video scrambler, comprising:
a parser for parsing the content of a digital-encoded input video stream to detect a header portion thereof,
a controller for generating a pseudo random-number, and determining a substituted-character position in said input video stream other than said detected header portion, using said pseudo random-number
a substitutor for performing a scramble processing of said input video stream by a character substitution processing at said determined position, and
an output unit responsive to said substitutor for outputting said scramble-processed video stream.

2. The digital video scrambler according to claim 1, further comprising
an input unit for inputting information for specifying a scramble level corresponding to said inputted video stream,
an encryption key generator for creating a private key, and
an encryption unit for encrypting and outputting said inputted information by using said private key,
wherein said controller uses said information in addition to said pseudo random-number.

3. The digital video scrambler according to claim 1, further comprising
an encryption parameter generator for generating a pseudo random-number to create a substitution table, and
said substitutor performs said character substitution processing by using said substitution table.

4. The digital video scrambler according to claim 2, further comprising
an encryption parameter generator for generating a pseudo random-number to create a substitution table, and
said substitutor performs said character substitution processing by using said substitution table.

5. The digital video scrambler according to claim 1,
wherein there are provided said substitutor in plural number, and said controller determines substituted-character positions each of which corresponds to each of said plural substitutors, and allocates said substituted-character positions to said plural substitutors.

6. The digital video scrambler according to claim 2,
wherein there are provided said substitutor in plural number, and said controller determines substituted-character positions each of which corresponds to each of said plural substitutors, and allocates said substituted-character positions to said plural substitutors.

7. The digital video scrambler according to claim 3,
wherein there are provided said substitutor in plural number, and said controller determines substituted-character positions each of which corresponds to each of said plural substitutors, and allocates said substituted-character positions to said plural substitutors.

8. A digital video descrambler connected via a network to said scrambler according to claim 1, said descrambler comprising:
a unit for acquiring said substitution-processed inputted video stream,
a parser for parsing said content of said inputted video stream to detect said header portion thereof,
a controller for generating a pseudo random-number based on a private key, and determining a substituted-character restoring position other than said header portion using said pseudo random-number, and
an inverse substitutor for performing a substituted-character restoration processing at said determined position.

9. The digital video descrambler according to claim 8, further comprising
an output unit for outputting identification information via said network, and
a receiver for receiving said private key via said network, said private key being sent out as a result of an authentication based on said identification information.

10. A scramble program, comprising the steps of:
generating a pseudo random-number to create a substitution table, and holding said substitution table,
outputting said substitution table via a network,
acquiring an encoded video signal via an input unit,
parsing the signal of said encoded video signal,
determining whether or not to perform a character substitution to said signal, and
transforming said signal in accordance with said substitution table if it has been judged to perform said character substitution,
wherein a signal subsequent to said signal is read in, and said steps are repeated until said video signal has disappeared, a determination criterion as to whether or not to perform said character substitution being modified in correspondence with said parsed result.

11. The scramble program according to claim 10,
wherein said substitution table is outputted in a state of being encrypted, and further comprising
a step of exchanging key information with a computer at an output destination of said encoded signal, said key information being necessary for decrypting said encryption.

12. A descramble program, comprising the steps of:
acquiring, via a network, an encoded signal, information on a cipher decryption, and information on a substitution table used for said encoding,
creating, from said information on said substitution table, a substitution-decrypting table corresponding thereto, and recording said substitution-decrypting table into a record means,
reading said signal, and parsing the syntax for encoding said signal,
judging whether or not to substitution-decrypt said signal using said parsed result, and
substitution-decrypting said signal that has been judged to be substitution-decrypted using said substitution-decrypting table,
wherein a signal next to said read-in signal is read in, and said steps are repeated.
